(19) United States
(12) Patent Application Publication
(10) Pub. No.: US 2011/0090676 A1
(43) Pub. Date: Apr. 21, 2011

(54) Illuminated Decorative Trim Assembly

(76) Inventor: Patrick Sortor, Waterford, MI (US)

(21) Appl. No.: 12/905,293

(22) Filed: Oct. 15, 2010

Related U.S. Application Data
(60) Provisional application No. 61/252,287, filed on Oct. 16, 2009.

(51) Int. Cl. F21S 8/00; F21V 11/00; F21V 14/08

(52) U.S. Cl. 362/145; 362/236; 362/232; 362/237

(57) ABSTRACT

The present invention relates to illuminated trim members configured for use with homes, building or otherwise. In one exemplary embodiment, the present invention provides an illuminated decorative trim assembly including a trim member. The trim member includes an upper member, a lower member and a connecting member joining the upper and lower members. The upper member, lower member or both form a plurality of openings along a length thereof. The trim assembly further includes a light fixture assembly including a plurality of receptacles aligned with the plurality of openings formed on the upper or lower member. The trim assembly also includes a plurality of electrically connected illuminating devices disposed along the light fixture assembly and in the receptacles. The trim assembly still further includes one or more translucent members disposed along the length of the upper or lower member to cover at least a portion of the plurality of openings.

### CROSS-REFERENCE TO RELATED APPLICATION

The present application claims benefit of U.S. Provisional Patent Application No. 61/252,287, filed Oct. 16, 2009, the contents of which are hereby incorporated by reference in its entirety for all purposes.

### FIELD OF THE INVENTION

The present invention relates to illuminated trim members configured for use with homes, buildings or otherwise.

### BACKGROUND

Interior and exterior illumination of homes, buildings or other structures is traditionally provided for seasonal events such as Christmas, Hanukkah, Halloween or otherwise. While pleasurable, installation and removal of such illumination is time consuming and can be dangerous. For example, traditional exterior illumination comprises strands of ornamental lights being fastened, such as through nails, brackets, clips or otherwise, to exterior portions of buildings. Prior to the seasonal event, individuals are required to ascend ladders or other devices to reach areas of the building which illumination is desired. The process is repeated along the length and/or around the exterior of the building wherever light is desired. Many times, this requires heights in access of ten feet and manipulation around shrubs, plants, or otherwise, with ladders or other functionally similar devices.

Some manufactures have developed permanent or semi-permanent illumination devices configured for installation on buildings. These illumination devices obscure or hide all or a portion of associated lights through an enclosure that is configured to open and close to expose and hide the illumination device. This is particularly advantageous where local ordinances restrict period of times when seasonal lights may be displayed. However, many of these prior illumination devices are costly, complex in design and problematic with respect to exterior environment conditions. For example, with illumination devices configured for opening to expose the lights, birds, insect and other pests utilize the housing to build homes or seek refuge. Upon opening of the illumination device, in order to expose the lights, pests, particularly bees, wasps or otherwise, may defend their nest potentially resulting in harm to individuals. Also, the structures of prior illumination devices are complex in design and in manufacturing, thereby making the prior illumination devices cost prohibitive.

In another aspect, prior illumination devices, including the above descried enclosed illumination devices, have been particularly one-dimensional when it comes to providing seasonal or other illumination. Such illumination devices include lights that are directly exposed to viewers and are arranged in a substantially fixed configuration. Once exposed, the illumination devices are either turned on or off, which may be sufficient for a single seasonal holiday or event, but is not suitable for multiple seasonal holidays. Further, the illumination provided is based solely on the light generated by the illumination device, which at times, particularly with certain bright lights such as light emitting diodes, can be overwhelming for certain viewers, or otherwise fail to provide a desired illumination.

In view of the foregoing, there is a need for improved methods and devices for providing improved interior and exterior illumination of a building structure.

### SUMMARY OF THE INVENTION

The present invention provides methods and devices for improved illumination that is useable in both interior and exterior portions of a home or building. In one aspect, the illumination is permanently or semi-permanently mounted to a building structure and comprises a typical building structure such as a trim, fascia, siding or other building structure. The present invention provides a discrete illumination device that in one mode of operation is substantially hidden to persons passing by such device. Accordingly, but not for activation of the illumination device, it would not be known that such illumination exists with the building structure. In another aspect, the present invention provides methods and devices for forming seasonal illumination that provides improved illumination and greater illumination versatility, both at a lower cost than prior systems. This improvement is based, at least in part, upon the ability to modulate illumination to change the light distribution emanating from the illumination device, i.e. pattern, brightness, color or otherwise. In still another aspect, the illumination device reduces pest problems with other illumination devices by providing an illumination device that is substantially sealed to prevent pest from entering into a cavity of the illumination device. Furthermore, the illumination device eliminates or substantially reduces the amount of access necessary to the lights by providing an illumination device that is in communication, either by wireless means, hardwired means or both, with a control or electrical system of the building structure. Still further, the illumination device does not require physical opening of any compartment to allow viewing of the illumination device. It should be appreciated that other advantageous aspects of the present invention are provided, as shown and described herein.

In view of the foregoing, in one embodiment, the present invention provides an illuminated decorative trim assembly. The trim assembly includes a trim member including an upper member, a lower member and a connecting member joining the upper and lower members to form a cavity. The upper member, lower member or both define a plurality of openings along a length thereof. The trim assembly further includes a light fixture assembly including a base having a width generally corresponding to a width of the upper or lower member having the plurality of openings. The light fixture assembly further includes a plurality of individual light fixtures disposed along a length of the base. The plurality of individual light fixtures define receptacles that are aligned with the plurality of openings formed by the upper or lower member. The trim assembly further includes an illumination device including a plurality of electrically connected lights disposed along the light fixture assembly and within the receptacles. The illumination device includes a first connector located at a first end of the illumination device and a second connector located at a second end of the illumination device to electrically connect to another illumination device or power supply. The illumination device further includes an illumination control device disposed along the upper or lower member having the plurality of openings. The illumination control device includes a first set of illumination control segments covering the plurality of openings formed along the upper or lower members, wherein the first set of illumination control segments are transparent or translucent to allow light from the plurality of lights to pass through a trim member having an exterior surface and an interior surface.

The above-described and other features and advantages of the present invention will be appreciated and understood by those skilled in the art from the following detailed description, drawings, and appended claims.

### BRIEF DESCRIPTION OF THE DRAWINGS

Other objects, features, advantages and details of the present invention appear, by way of example only, in the following detailed description of preferred embodiments of the invention, the detailed description referring to the drawings in which:

FIGS. 1 and 2 illustrate exemplary embodiments of illuminated trim assemblies of the present invention attached to exterior portions of different building structures according to the teachings of the present invention;

FIGS. 3 and 4 illustrate exemplary embodiments of illuminated trim assemblies of the present invention attached to interior portions of a building structure according to the teachings of the present invention;

FIG. 5 illustrates a perspective view of an exemplary embodiment of a corner section of an illuminated trim assembly according to the teachings of the present invention;

FIG. 5A illustrates a cross-sectional view of the illuminated trim assembly shown in FIG. 5;

FIG. 6 illustrates a perspective view of an exemplary embodiment of an illuminated trim assembly according to the teachings of the present invention;

FIG. 7 illustrates a partial exploded perspective view of two sections of an illuminated trim assembly according to the teachings of the present invention;

FIG. 8 illustrates a cross-section view taken through a section of the illuminated trim assembly shown in FIG. 7;

FIG. 9 illustrates an enlarged view of a transparent or translucent portion shown in FIG. 8;

FIG. 10 illustrates alternate configurations of the transparent or translucent portion shown in FIG. 9 according to the teachings of the present invention;

FIG. 11 illustrates an enlarged view of a trim member according to the teachings of the present invention;

FIG. 12 illustrates alternate configurations of the trim member shown in FIG. 11 according to the teachings of the present invention;

FIG. 13 illustrates a cross-section view of another exemplary embodiment of an illuminated trim assembly according to the teachings of the present invention;

FIG. 14 illustrates a cross-section view of another exemplary embodiment of an illuminated trim assembly according to the teachings of the present invention;

FIG. 15 illustrates a cross-sectional view of the illuminated trim assembly shown in FIG. 6, wherein the illuminated trim assembly is in an open position;

FIG. 16 illustrates a perspective view of another exemplary embodiment of an illuminated trim assembly of the present invention;

FIG. 17 illustrates a cross-sectional view of the illuminated trim assembly shown in FIG. 16;

FIG. 18 illustrates a schematic view of an exemplary illumination control system for an illuminated trim assembly according to the teachings of the present invention; and

FIG. 19 illustrates a schematic view of another exemplary illumination control system for an illuminated trim assembly according to the teachings of the present invention.

### DESCRIPTION OF THE PREFERRED EMBODIMENTS

The present invention relates to methods and devices for providing improved indoor and outdoor illumination, such as seasonal lighting or otherwise. In one aspect, advantages of the present invention are derived through a simplistic discrete illumination device that is configured to remove annual installation and removal requirements of lights. Illumination of the device is achieved through a remote switch in communication with the illumination device that is accessible from within a building structure. In another aspect, advantages of the present invention are derived through improved illumination disseminating from the improved illumination device. Other advantages of the present invention will be appreciated as shown and described herein.

Referring to FIGS. 1 through 4, exemplary embodiments of an illuminated trim assembly 10 of the present invention are shown mounted on interior and exterior portions of building structures, namely a home 12 and office building 14. In these embodiments, the illuminated trim assembly 10 includes a plurality of trim sections 16 joined together. The trim sections 16 are physically and electrically connected together and to a power supply of the corresponding building structure to allow a user to control illumination of the illuminated trim assembly. In one exemplary embodiment, control of the illuminated trim assembly is integrated within the building structure.

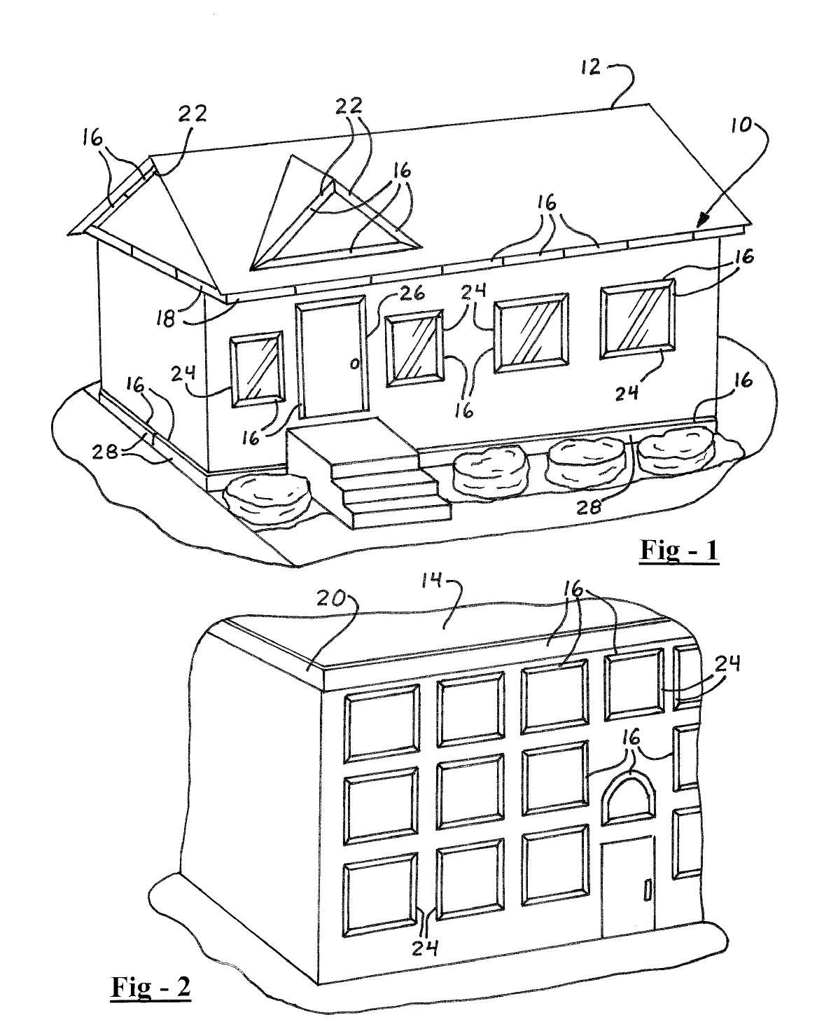

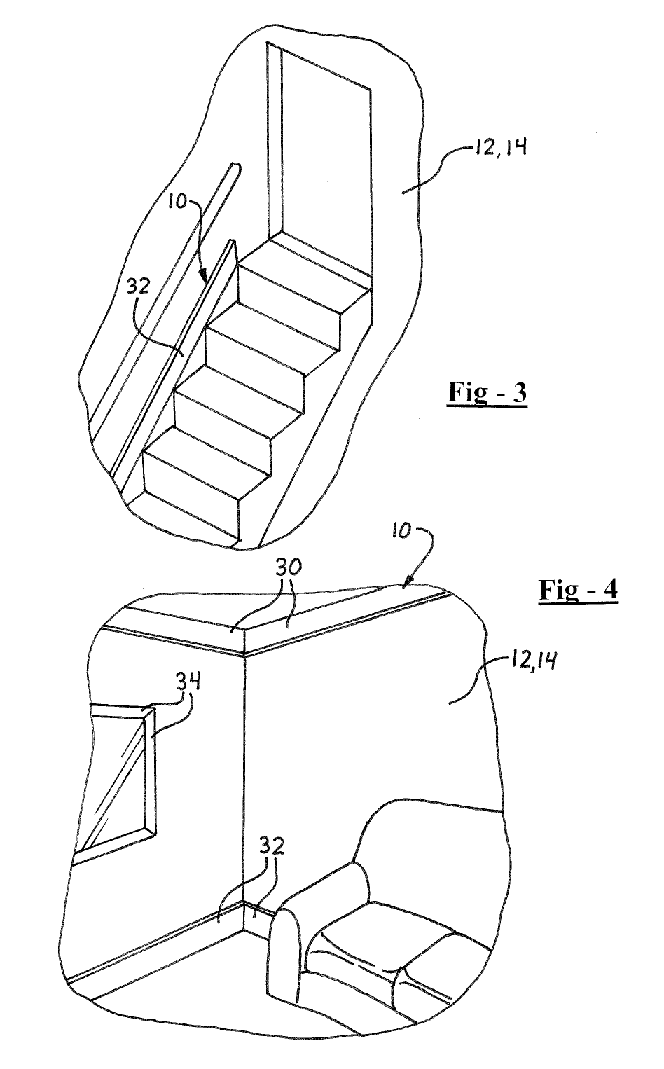

The trim sections 16 may be configured in size and shape to form various interior and exterior building components, such as trim members, molding members or otherwise. For example, with particular reference to exterior applications shown in FIGS. 1 and 2, the trim sections 16 may comprise or be applied or attached over cave trim 18, roof trim 20, peak trim 22, window trim 24, door trim 26, ground or base trim 28 or other trim members. In another example, with particular reference to the interior applications shown in FIGS. 3 and 4, the trim sections 16 may comprise crown molding 30, baseboard molding 32, window molding 34, or other mold members. Other building components are possible.

The trim sections 16 are joined together to form the illuminated trim assembly 10 of the present invention. Alternatively, a single trim section may comprise the entire illuminated trim assembly. In one configuration, the illuminated trim assembly includes one or more joints 36 suitable in strength for maintaining the trim sections 16 together. Such joints may be formed through a friction fitting, male and female fittings, snap-fitting, combinations thereof or otherwise. Such joints may also include an additional member configured to engage and join together the trim sections 16.

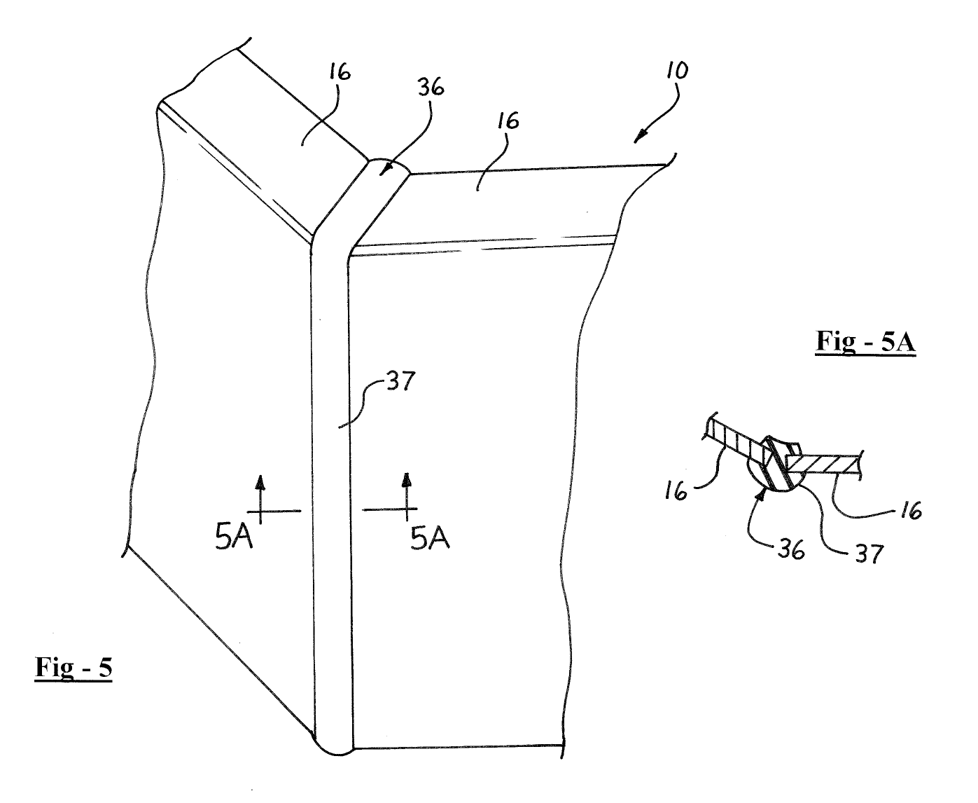

In one configuration, referring to FIGS. 5 and 5A, one or more seal members 37 are provided for sealing of interior and exterior portions of trim sections 16. Such seal members may additional or alternatively be configured for attachment of trim section 16 and as such may include a male and/or female fittings, snap-fittings, friction fittings, adhesives, combinations thereof or otherwise. Examples of suitable seals include gaskets, adhesives, sealant material, combinations thereof or otherwise. In view of the foregoing, such joints may be configured for maintaining alignment of trim sections 16, for forming angles with respect to trim sections, such as shown in FIG. 5A or otherwise. Such angles may include any angle for forming a continuous section along a building structure.

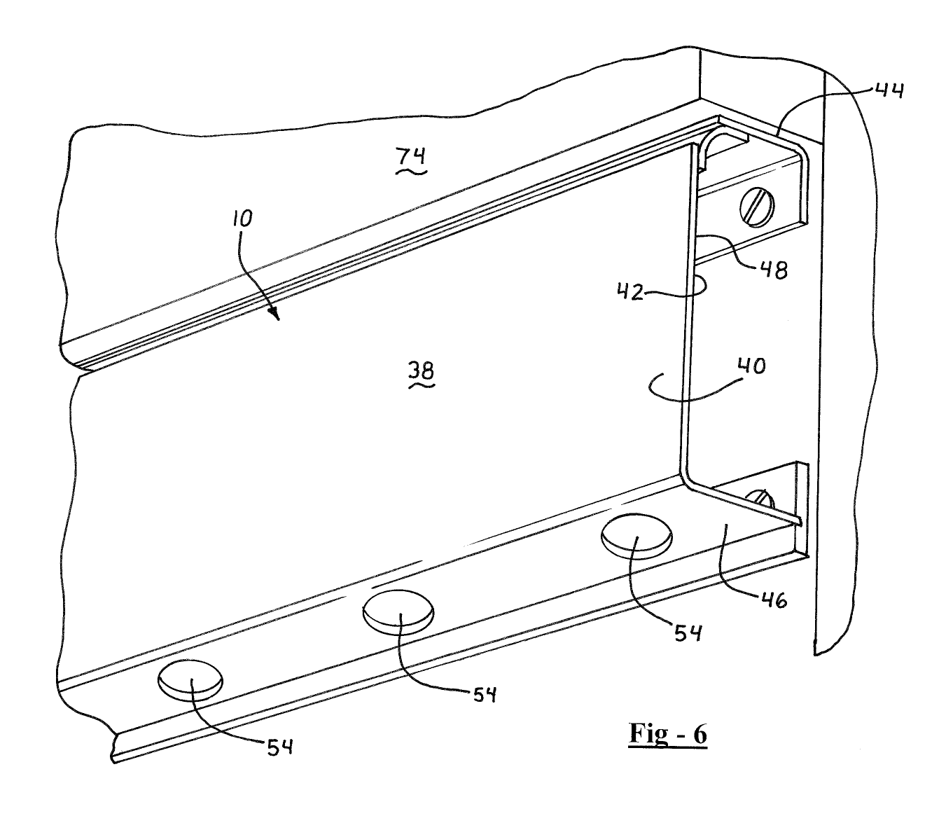

Referring to FIGS. 6 through 8, exemplary embodiments of illuminated trim assemblies 10 are shown. The illuminated trim assembly 10 includes a trim member 38 having an exterior surface 40 and an interior surface 42. The trim member includes an upper member 44, a lower member 46 and a connecting member 48. The connecting member joins the upper member to the lower member and forms a ‘C-shaped’ configuration for providing the ability of 180° illumination. Further, in one exemplary embodiment the trim members 38 form an internal cavity 86 for housing various components of the illuminated trim assembly 10. As previously indicated, the cavity and components housed therein may be substantially sealed from the surrounding environment. In one exemplary embodiment, the upper member 44, lower member 46 or both include a retaining member 50, such as a lip, re-curved member or otherwise, for forming a groove 52 along a length of the trim member. Further, in one exemplary embodiment, the upper member, lower member or both include a plurality of openings 54 for allowing the transmission of light through the trim member 38.

The illuminated trim assembly 10 further includes an attachment feature, such as a light fixture assembly 56, for attachment of an illumination device 57 to the trim member 38. In one embodiment, the illumination device 57 includes a plurality of lights 58. The light fixture assembly 56 includes a base 60 having a width generally corresponding to a width of the upper or lower member 44, 46 and is configured for placement within the groove 52 formed by the trim member 38. The light fixture assembly 56 further includes a plurality of individual light fixtures 62 forming a plurality of receptacles 64 for receiving the plurality of lights 58. In the configuration shown, the base 60 includes a plurality of openings 66 that are aligned with the plurality of receptacle 64 for providing transmission of light through the trim member 10.

The plurality of lights 58 may comprise any suitable light including incandescent lights, light emitting diodes (LEDs) or otherwise. In one preferred embodiment, the lights 58 comprise LEDs for providing improved illumination intensity. This improved illumination capability expands the scope of potential light dissemination. As described herein, this increased potential illumination allows for a greater scope of illumination of light such as through the use of color or light filters, light dissemination or intensification, or otherwise.

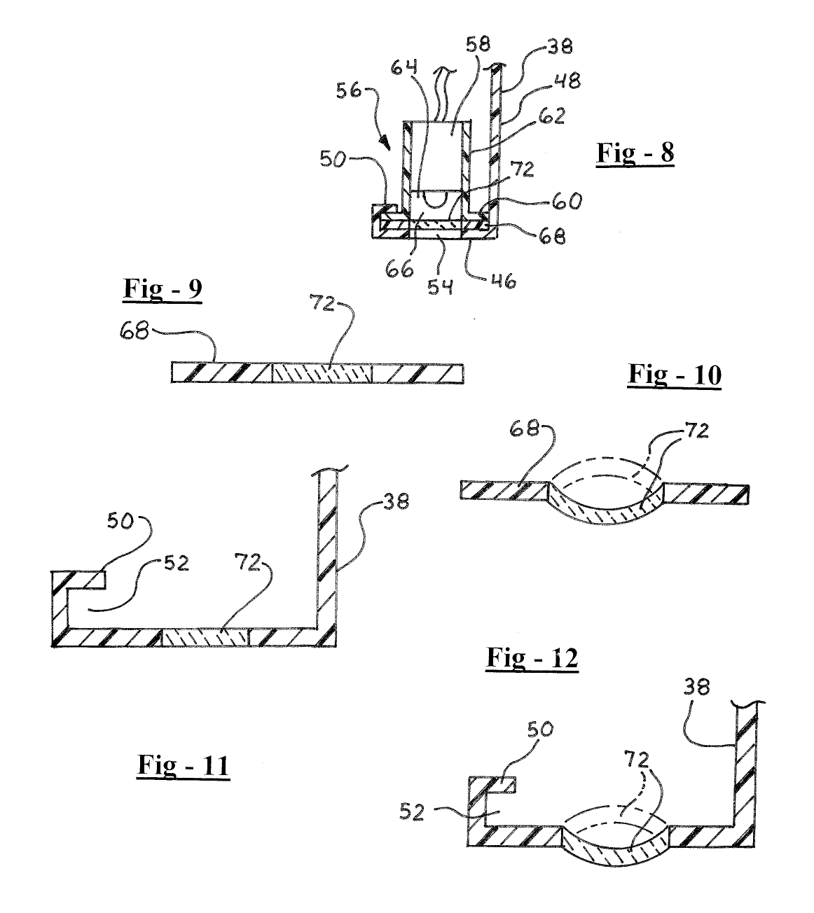

In one exemplary embodiment, the illuminated trim member 10 further includes an illumination control device 68 for effecting or modifying the transmission of light from within the trim member 60. The illumination control device 68 may also be used for enclosing the lights within the trim member. In one configuration, the illumination control device 68 includes a plurality of openings 70 for allowing light transmission therethrough. In another configuration, referring to the embodiment shown in FIGS. 8 and 9, the illumination control device 68 includes one or more, or plurality of transparent or translucent illumination control segments 72. The plurality of openings 70 and illumination control segments 72 are aligned with the openings 52 formed through the trim member 38 and openings 66 formed through the light fixture assembly 56. The combination of openings allows light located within the receptacles 64 to transmit through the illuminated trim assembly 10 to provide exterior illumination.

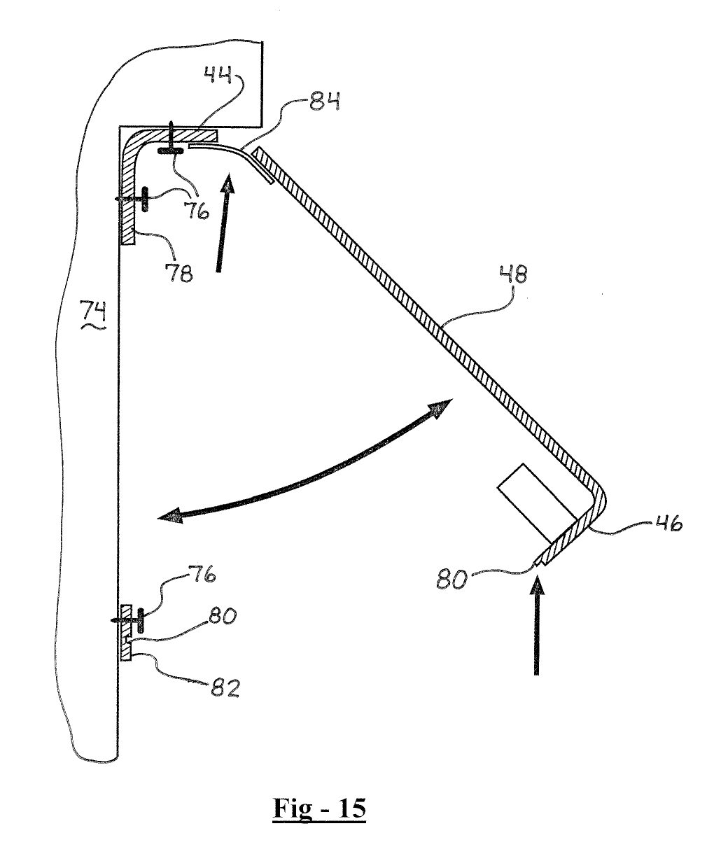

In one exemplary embodiment, referring to FIG. 10, one or more of the transparent or translucent illumination control segments 72 are arcuate in a convex or concave manner to disseminate or intensify the light exiting the illuminated trim assembly 10. In another configuration, referring to FIGS. 11 and 14, the upper or lower member 44, 46 includes a transparent or translucent portion located within openings 54. In this configuration, it is foreseeable that the transparent or translucent illumination control segments 72 of the illumination control device 68 are replaced by openings 70 formed through the base or otherwise may be simply clear, include color or is otherwise light filtering. In yet another configuration, referring to FIG. 12, it is contemplated that the transparent portion disposed within the openings 54 of the upper or lower member 44, 46 are arcuate in a convex or concave manner to disseminate or intensify the light exiting the illuminated trim assembly 10.

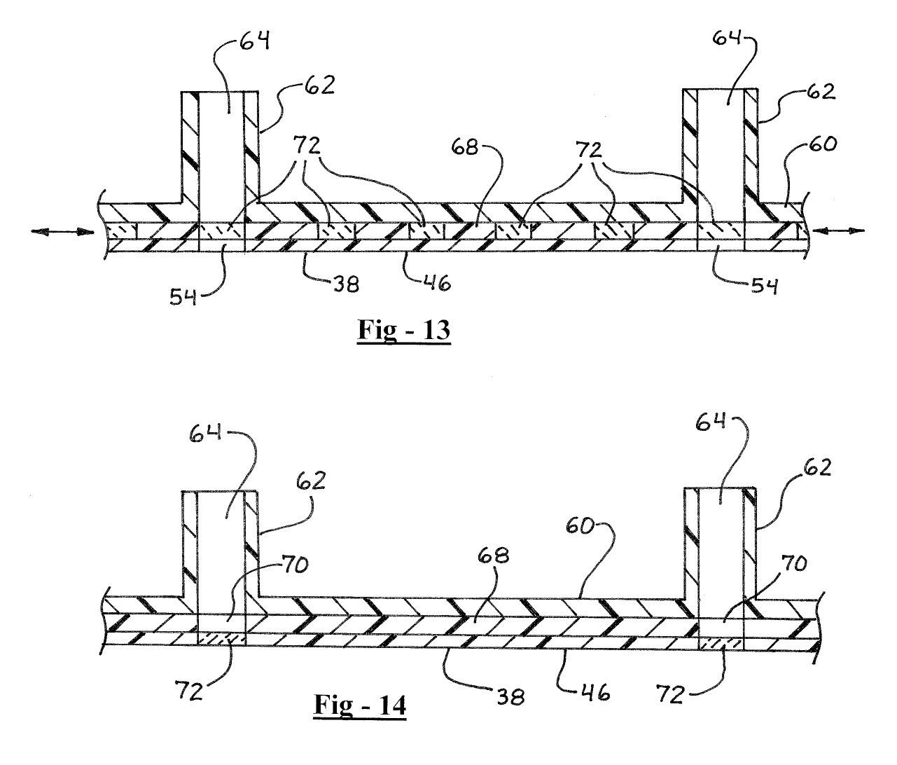

In one exemplary embodiment, it is contemplated that the number of transparent or translucent illumination control segments 72 of illumination control device 68 are equal and aligned with the number of receptacles 64 and openings 54 of the upper or lower member 44, 46. However, in another exemplary embodiment, referring to FIG. 13, it is contemplated that the number of transparent or translucent illumination control segments 72 are greater or less than the number of receptacles 64 and openings 54. Advantageously, upon sliding movement of the illumination control device 68 with respect to the receptacles 64 and openings 54 it is possible to change which transparent or translucent portions are aligned therewith. This may be performed manually or through a suitable motor that is controlled through a control switch of the illuminated trim assembly 10. This feature provides different illumination effects by providing the ability to align different illumination control segments 72, e.g. transparent or translucent portions with the lights 58. For example, it is possible that the illumination control segments 72 may be different to allow a change in color by providing different color illumination control segments 72, change in dissemination of illumination by providing concave and/or convex illumination control segments 72, change in brightness by providing different clear/transparent or different levels of opaqueness of the illumination control segments 72, combinations thereof or otherwise.

The illuminated trim assembly 10 is configured for attachment to a building structure through suitable attachment means. In one exemplary embodiment, referring to FIG. 15, the illuminated trim assembly 10 is attached to a building structure 74, using fasteners 76, i.e. nails, screws or otherwise. In this embodiment, the illuminated trim assembly 10 includes an upper member 44 including a first attachment feature 78 and a lower member 46 including a snap-fitting 80 configured for attachment to a second attachment feature 82. The upper member 44 is attached to the connecting member 48 through a hinge 84, such as a living hinge or otherwise. The hinge may be formed of any suitable materials including metal, plastic, rubber, latex or otherwise. In this configuration, a seal is formed between an interior cavity 86 of the illuminated trim assembly 10 and an exterior region 88.

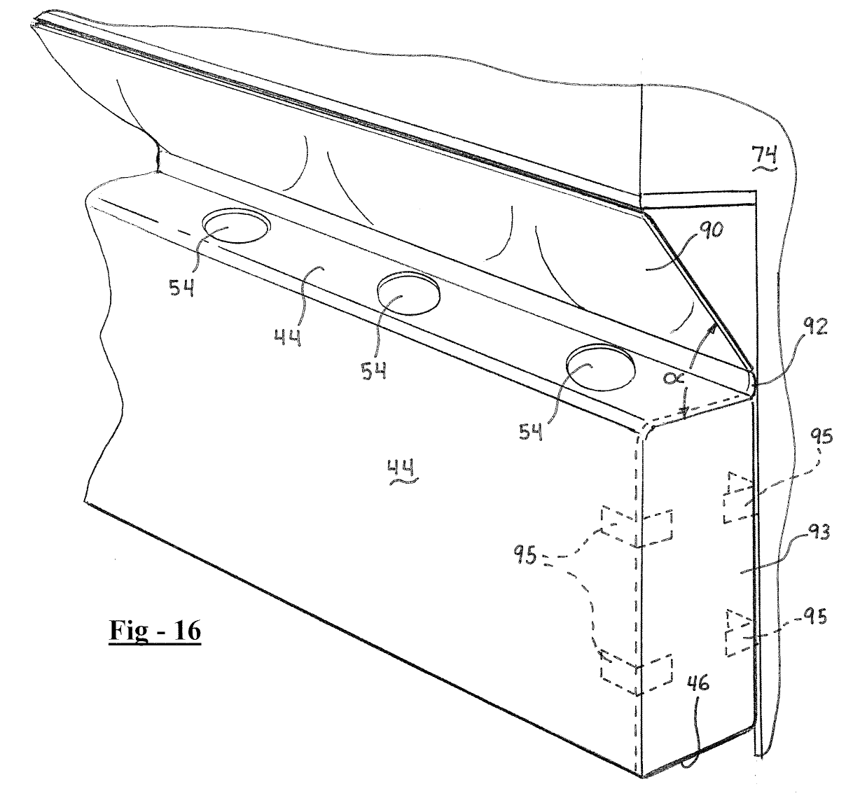

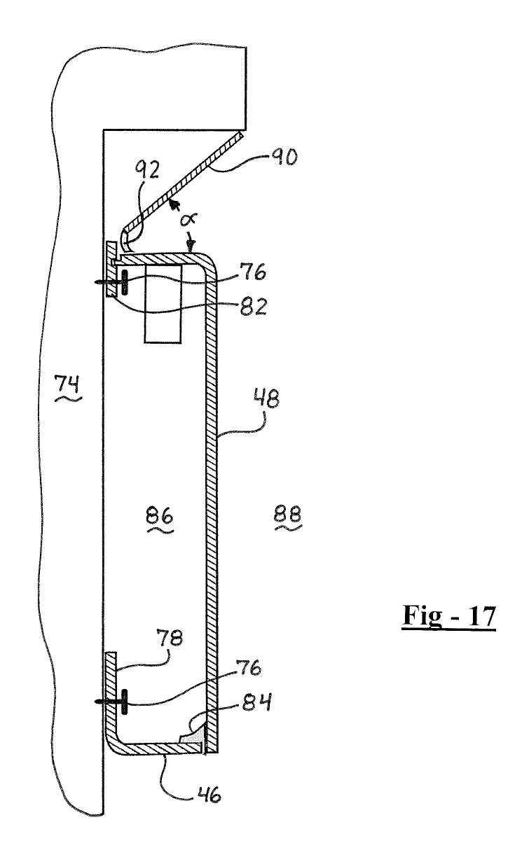

In another exemplary embodiment, referring to FIGS. 16 and 17, an illuminated trim assembly 10 is shown including a reflector 90 disposed proximate to the openings 54 formed through the upper member 44. The reflector 90 is angled with respect to the receptacles 64 of base 60 to provide redirection of illumination generated by lights 58. In one configuration, the reflector 90 is positioned at an angle ‘α’ that is approximately 30° to 60° with respect to the upper or lower members 44, 46. In another configuration, the reflector is positioned at angle ‘α’ that is approximately 45° with respect to the upper or lower members 44, 46. Other configurations are possible. In one exemplary embodiment, the reflector 90 is attached to the upper or lower member 44, 46 through a suitable attachment feature, such as hinge 92, or more so a living hinge or otherwise. The hinge may be formed of any suitable materials including metal, plastic, rubber, latex or otherwise. This configuration allows adjustment of the reflector to a suitable angle with respect to the upper or lower member 44, 46, such as between an angle ‘Δ’ of about 0° to 180°. Suitable material for forming the reflector includes metal, plastic (e.g., white plastic), glass or otherwise.

It is contemplated that in one embodiment the illuminated trim assembly 10 is configured to limit or restrict pest, such as birds, flying insects, rodents or otherwise in accessing the interior cavity 86. In one configuration, a seal is formed between the interior cavity 86 and exterior region 88. Accordingly, it is contemplated that the illuminated trim assembly 10 includes additional components, such as end cap 93, for closing off the interior cavity. The end cap 93 is attached to the trim member 38 and building structure 74 through one or more attachment features, such as clip 95. It is further contemplated that seals may be provided or formed between the components of the illuminated trim assembly 10. Such seals may comprise adhesives, sealants, gaskets or otherwise.

The components of the illuminated trim assembly 10 may be formed of any suitable material including metals or plastics. In one configuration, the components of the illuminated trim assembly 10 are formed of a non-conductive or low-conductive plastic material, such as vinyl or otherwise. The components may be formed using any suitable means including molding, extrusion or otherwise.

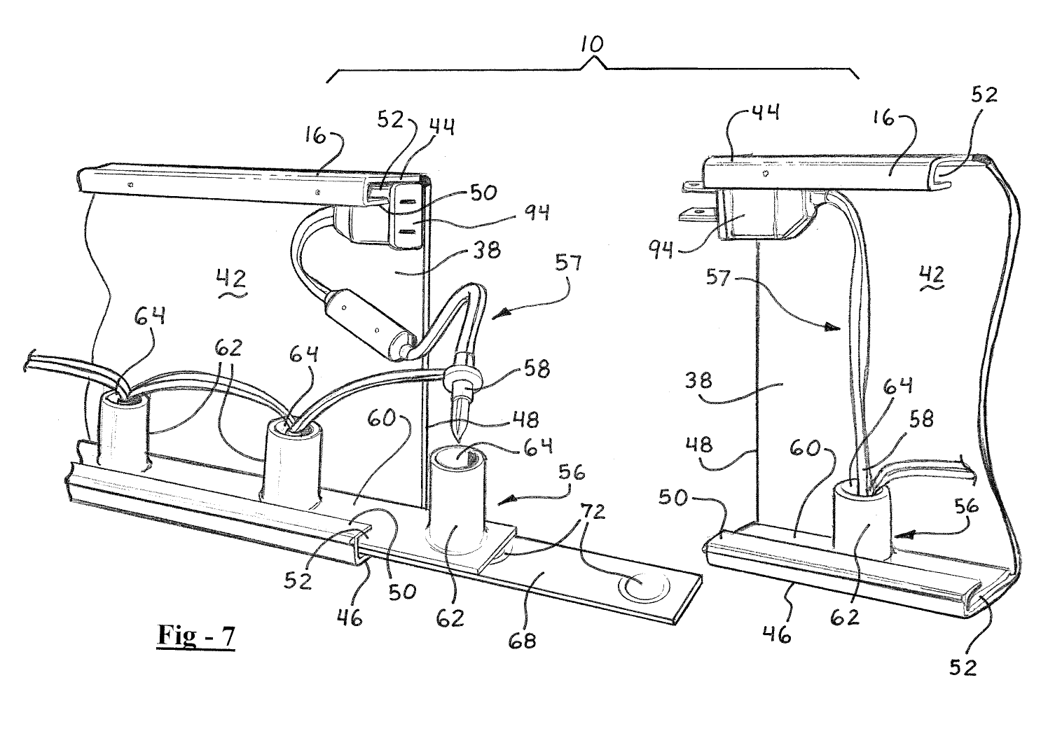

Referring to FIG. 7, in one configuration, each trim section 16 includes a trim member 38, light fixture assembly 56, lights 58 and illumination control device 68. The lights are configured for connection to each other to form a continuous strand of lights. In one configuration, the connection comprises typical electrical connectors 94. However, a continuous strand of lights may be used, i.e. without connectors, or other connectors may be used.

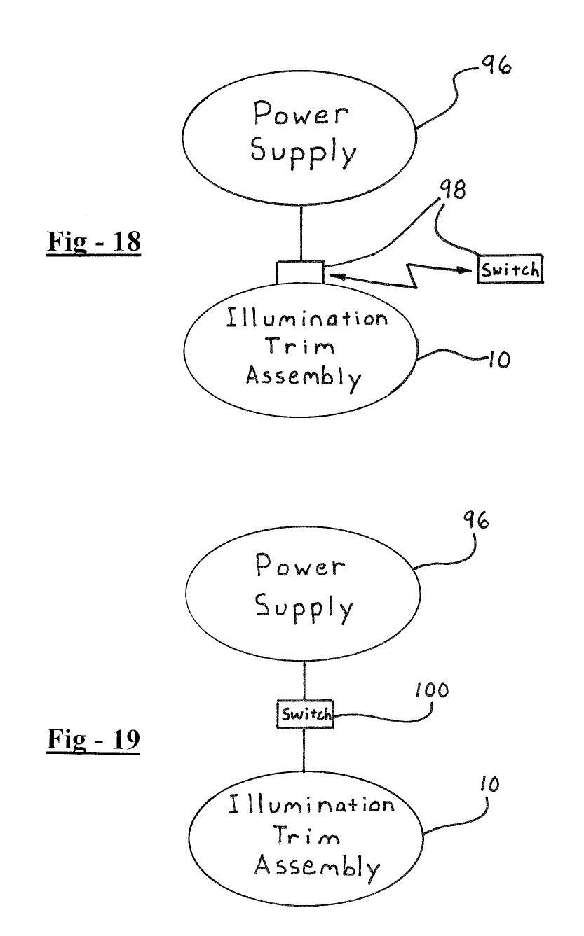

Referring to FIGS. 18 and 19, the lights 58 of the illuminated trim assembly 10 are configured for connection to a power supply 96 of a building structure, such as home 12, office building 14 or otherwise. The illuminated trim assembly 10 may be connected to a power supply 96 through a plug connector 94 or it may be hardwired into the building structure. In one particular configuration, referring to FIG. 18, the illuminated trim assembly 10 is connected to the power supply 96 of the building structure 74. Power to the illuminated trim assembly 10 is controlled through an electrically controlled switch 98 that is controllable through a wireless remote control device. Such remote control devices may comprise a handheld device, wall switch or otherwise. In another particular configuration, referring to FIG. 19, the illuminated trim assembly 10 is electrically connected to a power supply 96 and controlled through a manual switch 100, such as a wall switch or otherwise. Other configurations are possible.

While the invention has been described with reference to a preferred embodiment it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An illuminated decorative trim assembly, comprising:
a trim member including an upper member, a lower member and a connecting member joining the upper and lower members to form a cavity, the upper member, lower member or both define a plurality of openings along a length thereof;
a light fixture assembly including a base and a plurality of individual light fixtures disposed along a length of the base, the plurality of individual light fixtures define receptacles that are aligned with the plurality of openings formed by the upper or lower member;
an illumination device including a plurality of electrically connected lights disposed along the light fixture assembly and within the receptacles; and
an illumination control device disposed along the upper or lower member having the plurality of openings, the illumination control device includes a first set of illumination control segments covering the plurality of openings formed along the upper or lower members, wherein the first set of illumination control segments are transparent or translucent to allow light from the plurality of lights to pass through.

2. The illuminated decorative trim assembly of claim 1, wherein the illumination control segments are attached to the trim member.

3. The illuminated decorative trim assembly of claim 1, wherein the illumination control segments are formed on a member separate from the trim member and light fixture assembly.

4. The illuminated decorative trim assembly of claim 3, wherein the illumination control device is moveable with respect to the trim member and light fixture assembly.

5. The illuminated decorative trim assembly of claim 4, wherein the illumination control device includes a second set of illumination control segments that are translucent or transparent.

6. The illuminated decorative trim assembly of claim 5, wherein in a first position the first set of illumination control devices are aligned with the plurality of openings of the trim member and plurality of light fixtures, and wherein in a second position the second set of illumination control segments are aligned with the plurality of openings of the trim member and plurality of light fixtures.

7. The illuminated decorative trim assembly of claim 4, wherein the illumination control device is formed of transparent or translucent material and includes an opaque layer which defines the first set of illumination control segments.

8. The illuminated decorative trim assembly of claim 1, wherein at least some of the illumination control segments include a color tint.

9. The illuminated decorative trim assembly of claim 8, wherein at least one of the first or second set of illumination control segments include a color tint.

10. The illuminated decorative trim assembly of claim 1, wherein the first set of illumination control segments includes a plurality of lenses for diffusing or intensifying light emanating from the plurality of electrically connected lights.

11. The illuminated decorative trim assembly of claim 1, further comprising a reflector disposed adjacent the upper or lower member having the plurality of openings.

12. The illuminated decorative trim assembly of claim 11, wherein the reflector is disposed at an angle between about 30° to 60° with respect to the upper or lower member having the plurality of openings.

13. The illuminated decorative trim assembly of claim 12, wherein the reflector is rotatably attached to the trim member.

14. The illuminated decorative trim assembly of claim 1, wherein the connecting member and one of the upper or lower members are moveable with respect to the other of said upper or lower member to provide access to the cavity formed by the trim member.

15. The illuminated decorative trim assembly of claim 1, further comprising a first attachment feature for attachment of the upper or lower member to a building structure.

16. The illuminated decorative trim assembly of claim 15, further comprising a second attachment feature for attachment of the other of said upper or lower member to the building structure, wherein the first or second attachment feature comprises a snap-fitting.

17. The illuminated decorative trim assembly of claim 1, further comprising one or more end caps located on a first or second end of the trim member.

18. The illuminated decorative trim assembly of claim 1, wherein a first end, a second end or both ends of the trim member are configured for engagement with a corresponding end of another trim member to form a joint.

19. The illuminated decorative trim assembly of claim 1, wherein the illuminated decorative trim assembly forms a seal between the cavity and an exterior region of the decorative trim assembly.

20. The illuminated decorative trim assembly of claim 1, wherein the plurality of electrically connected lights comprise light emitting diodes.
